(19) United States
(12) Patent Application Publication
(10) Pub. No.: US 2026/0006698 A1
(43) Pub. Date: Jan. 1, 2026

(54) LAMP CONTROL SIGNAL TRANSMISSION METHOD AND SYSTEM BASED ON LEVEL SAMPLING

(71) Applicant: Guangzhou Rising Dragon Recreation Industrial Co., Ltd., Guangzhou (CN)

(72) Inventors: Ziqin GUO, Guangzhou (CN); Bo LIANG, Guangzhou (CN)

(73) Assignee: Guangzhou Rising Dragon Recreation Industrial Co., Ltd., Guangzhou (CN)

(21) Appl. No.: 18/830,615

(22) Filed: Sep. 11, 2024

(30) Foreign Application Priority Data
Jun. 28, 2024 (CN) 202410858217.X

(51) Int. Cl. H05B 47/11; H05B 45/34; H05B 47/14

(52) U.S. Cl. CPC H05B 47/11; H05B 45/34; H05B 47/14

(57) ABSTRACT

A lamp control signal transmission method includes level states of R, G and B lamp control signals in a four-wire system being synchronously sampled within a preset sampling period, a corresponding coded signal comprising a signal header and three bits of coded data corresponding to R, G and B control information carried by the level states of the three lamp control signals being generated, and then, the coded signal being superposed onto integrated power of the four-wire system to form composite power that is transmitted by a two-wire system to drive a load. Sampling lamp control signals within a complete period is not needed in the process of transforming a four-wire lamp system into a two-wire lamp system, the coded signal can be transmitted approximately synchronously at a low delay, and power transmission is guaranteed during two-wire signal transmission.

### FIELD

The invention relates to the technical field of lamp control signal transmission, in particular to a lamp control signal transmission method and system based on level sampling.

### BACKGROUND

Traditional four-wire lamp systems are widely used in the field of lamp control. In the four-wire lamp system, four wires are arranged to synchronously transmit power and lamp control signals, and the large number of wires leads to a high wiring cost and inconvenience in lamp installation. Moreover, due to the lack of a fixed voltage output of the four-wire lamp system, the brightness of an LED lamp is controlled by adjusting the duty cycle of lamp control signals, thus increasing the difficulty of system expansion. In view of this, an original traditional four-wire lamp system is often transformed into a two-wire system to reduce the number of wires.

However, when an existing four-wire lamp system is transformed into a two-wire lamp system, in order to accurately reproduce the brightness control function of the original system, lamp control signals in the four-wire lamp system need to be sampled within a complete period and then converted into coded signals to be transmitted to the two-wire lamp system. In this process, if the lamp control signals remain at a low duty cycle for an excessively long time, signal transmission fails easily due to the lack of power transmission of the system during two-wire signal transmission, leading to a failure to drive a lamp.

### SUMMARY

To solve the problem that in the prior art, in a case where a four-wire lamp system is transformed into a two-wire lamp system, signal transmission fails due to the lack of power transmission of the system when lamp control signals within a complete period are sampled and converted into coded signals to be transmitted, leading to a failure to drive a lamp, the invention provides an improved control signal transmission method and system based on level sampling.

In one aspect, the present invention provides a lamp control signal transmission method based on level sampling, comprising: Step S1: synchronously sampling, within a preset sampling period, level states of R (red), G (green) and B (blue) lamp control signals in a four-wire system to obtain level states of current R, G and B lamp control signals, wherein the level states comprise a high level and a low level; Step S2: generating and outputting a coded signal according to the level states of the lamp control signals, wherein the coded signal comprises a signal header and three bits of coded data corresponding to R, G and B control information carried by the level states of the lamp control signals; Step S3: integrating power of the three lamp control signals with power of a driving circuit in the four-wire system to obtain integrated power; Step S4: superposing the coded signal onto the integrated power to obtain composite power that is transmitted by a two-wire system; Step S5: receiving the composite power from the two-wire system and performing signal-power separation on the composite power to obtain driving power for driving a load, and the coded signal; and Step S6: decoding the coded signal, and after the signal header is read, performing timing and reading the three bits of coded data to obtain the R, G and B control information carried by the coded signal, and correspondingly outputting R, G and B control signals with a fixed duration to the load.

Preferably, Step S2 further comprises: every time one coded signal is generated, outputting the coded signal.

Preferably, Step S6 further comprises: after the R, G and B control signals with the fixed duration are generated, resetting the R, G and B control signals to an initial state, and then decoding a next coded signal, wherein the fixed duration is the same as a duration of the preset sampling period.

Preferably, Step S2 further comprises: every time one coded signal is generated, comparing the current coded signal with a previous coded signal; if the current coded signal is the same as the previous coded signal, not outputting the current coded signal; or, if the current coded signal is different from the previous coded signal, outputting the current coded signal.

Preferably, Step S6 further comprises: when a next signal header is read, performing retiming and reading another three bits of coded data and updating the output R. G and B control signals; and if the next signal header is not read exceeding a preset time, resetting the R, G and B control signals to an initial state.

In another aspect, the present invention further provides a lamp control signal transmission system based on level sampling, being suitable for the lamp control signal transmission method based on level sampling according to claim 1, the lamp control signal transmission system comprising a four-wire system input module, a sampling MCU, a power integration module, a signal superposition module, a two-wire system transmission module and an analysis module. The four-wire system input module is connected to an input terminal of the power integration module by means of a first positive wire, an R signal wire, a G signal wire and a B signal wire; an input terminal of the sampling MCU is connected to the R signal wire, the G signal wire and the B signal wire, and an output terminal of the sampling MCU is connected to the signal superposition module; the power integration module is sequentially connected to the signal superposition module and the two-wire system transmission module by means of a second positive wire and a first negative wire; a composite output terminal of the two-wire system transmission module is connected to a composite input terminal of the analysis module by means of a signal wire and a second negative wire, and a composite output terminal of the analysis module is connected to a load; the four-wire system input module is used for generating R (red), G (green) and B (blue) lamp control signals and outputting the R, G and B lamp control signals respectively by means of the R signal wire, the G signal wire and the B signal wire; the sampling MCU is used for sampling level states of three lamp control signals to obtain the level states of the current three lamp control signals, generating a corresponding coded signal according to the level states of the current three lamp control signals, and outputting the coded signal to the signal superposition module, wherein the level states comprise a high level and a low level; the coded signal comprises a signal header and three bits of coded data corresponding to R, G and B control information carried by the level states of the three lamp control signals; the power integration module is used for integrating power on the R signal wire, the G signal wire and the B signal wire with driving power on the first positive wire to obtain integrated power; the signal superposition module is used for superposing the coded signal onto the integrated power to obtain composite power and outputting the composite power to the two-wire system transmission module; the two-wire system transmission module comprises a third positive wire connected to the second positive wire and a third negative wire connected to the first negative wire, and is configured for transmitting the composite power and outputting the composition power to the analysis module; the analysis module comprises a signal-power separation unit and a receiving MCU; the signal-power separation unit is configured for performing signal-power separation on the composite power to obtain driving power for driving a load, and the coded signal; the receiving MCU is configured for receiving and decoding the coded signal, after the signal header is read, performing timing and reading three bits of coded data to obtain R, G and B control information carried by the coded signal, and outputting corresponding R, G and B control signals to the load.

Preferably, the lamp control signal transmission system further comprises an energy storage and voltage stabilization module which comprises a terminal connected to the first positive wire and the negative wire, and another terminal connected to the sampling MCU.

Preferably, the signal superposition module comprises a triode, a first resistor, a second resistor, a MOS transistor, a first diode, a second diode and a third resistor, a base of the triode is sequentially connected to the first resistor and an output terminal of the sampling MCU, an emitter of the triode is grounded, a collector of the triode is connected to the second resistor, the first diode is connected in series to the second diode and then connected in parallel to the MOS transistor, and the third resistor is connected between a drain and a gate of the MOS transistor and connected to an output terminal of the power integrated module; and the gate of the MOS transistor is connected to a terminal of the second resistor, and a source of the MOS transistor is connected to an input terminal of the two-wire system transmission module.

The invention has the following beneficial effects: according to the lamp control signal transmission method based on level sampling provided by the invention, level states of R, G and B lamp control signals in a four-wire system are synchronously sampled within a preset sampling period, a corresponding coded signal comprising a signal header and three bits of coded data corresponding to R, G and B control information carried by the level states of the three lamp control signals is generated, and then the coded signal is superposed onto integrated power of a four-wire system to form composite power that is transmitted by a two-wire system to drive a load. In this way, in the process of transforming a four-wire lamp system into a two-wire lamp system, lamp control signal transmission can be performed without sampling lamp control signals within a complete period, the coded signal can be transmitted approximately synchronously at a low delay, and power transmission is guaranteed during two-wire signal transmission, such that the problem that the load fails to be driven due to the lack of power of the system when the coded signal is transmitted in case of a low signal ratio of lamp control signals is solved.

According to the lamp control signal transmission system based on level sampling provided by the invention, a sampling MCU synchronously samples level states of R, G and B lamp control signals in a four-wire system input module within a preset sampling period, a corresponding coded signal comprising a signal header and three bits of coded data corresponding to R, G and B control information carried by the level states of the three lamp control signals is generated, power of the three lamp control signals in the four-wire system input module and driving power are integrated by a power integration module to obtain integrated power, a signal superposition module superposes the coded signal onto the integrated power to form composite power, the composite power is output to an analysis module by a two-wire system transmission module, and finally, the analysis module analyzes the composite power to control and drive a load, such that transformation from the four-wire lamp system to the two-wire lamp system is realized, the wiring cost is reduced, the universality and expandability of the system are improved, the coded signal can be transmitted approximately synchronously at a low delay, and the problem that the load fails to be driven due to the lack of power of the system in case of a low duty cycle is solved, thus improving the operating stability of the system.

### BRIEF DESCRIPTION OF THE DRAWINGS

FIG. 1 is a schematic flow diagram of a lamp control signal transmission method based on level sampling according to the invention;

FIG. 2 is a schematic flow diagram of sampling of level states of three lamp control signals according to Embodiment 1;

FIG. 3 is a schematic flow diagram of sampling level states of three lamp control signals according to Embodiment 2;

FIG. 4 is a schematic principle diagram of a lamp control signal transmission system based on level sampling according to the invention;

FIG. 5 is a schematic circuit diagram of a signal superposition module according to the invention.

### REFERENCE SIGNS

1, four-wire system input module; 2, sampling MCU; 3, power integration module; 4, signal superposition module; 5, analysis module; 51, signal-power separation unit; 52, receiving MCU; 6, load; 7, energy storage and voltage stabilization module; 8, two-wire system transmission module.

### DESCRIPTION OF THE EMBODIMENTS

To allow those skilled in the art to have a better understanding of the technical solutions of the invention, the invention is described in further detail below in conjunction with accompanying drawings. The embodiments described here are merely illustrative ones, and are not all possible ones of the invention. All other embodiments obtained by those ordinarily skilled in the art according to the following ones without creative labor should also fall within the protection scope of the invention.

### Embodiment 1

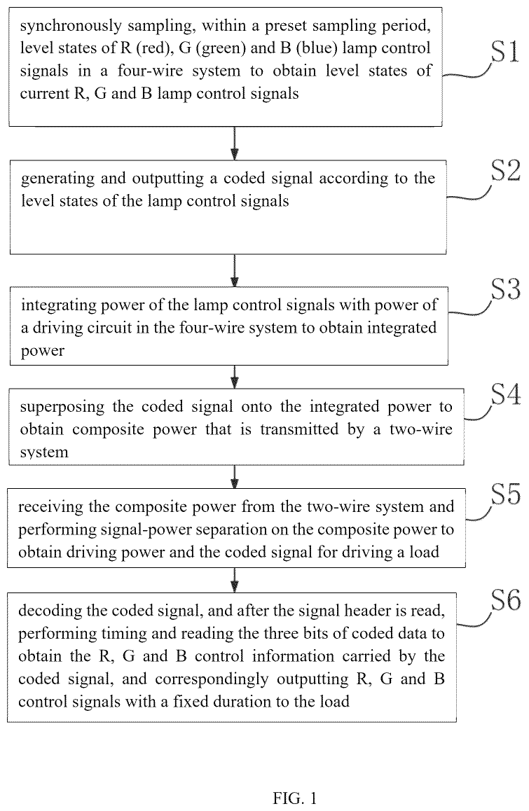

Referring to FIG. 1, a lamp control signal transmission method based on level sampling is suitable for system transformation from a four-wire lamp system to a two-wire lamp system and comprises Step S1-Step S6.

Step S1: level states of R (red), G (green) and B (blue) lamp control signals in a four-wire system are synchronously sampled within a preset sampling period to obtain level states of current R, G and B lamp control signals, wherein the level states comprise a high level and a low level. The synchronous sampling mechanism can accurately capture the level state of each lamp control signal, thereby preventing delays caused by a deviation of the sampling time.

Step S2: a corresponding coded signal is generated according to the level states of the three lamp control signals and is output, wherein the coded signal comprises a signal header and three bits of coded data corresponding to R, G and B control information carried by the level states of the three lamp control signals. Step S3: power of the three lamp control signals in the four-wire system and power of a driving circuit are integrated to obtain integrated power. In this embodiment, Step S2 and Step S3 are performed synchronously.

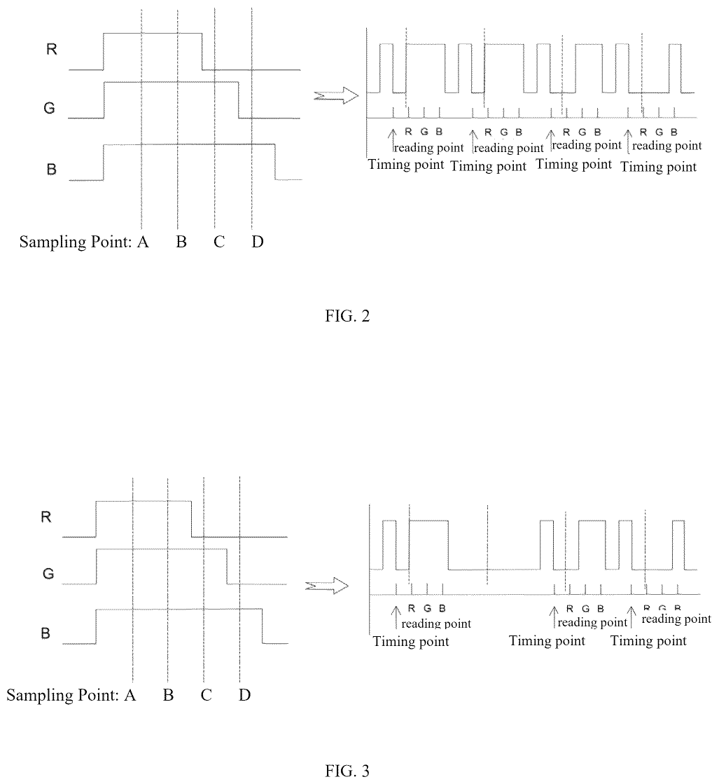

Specifically, referring to FIG. 2, within a preset sampling period, a plurality of sampling time points are set to synchronously sample level states of R (red), G (green) and B (blue) lamp control signals in a four-wire system to determine whether current R, G and B lamp control signals are at a high level or a low level, and then a coded signal comprising a signal header and three bits of coded data corresponding to R, G and B control information carried by the level states of the three lamp control signals is generated according to the level states of the three lamp control signals sampled at the current sampling time point. In this embodiment, the signal header is a high level.

By synchronously sampling the level states of the R, G and B lamp control signals within the preset sampling period, signal transmission can be completed without sampling original lamp control signals within a complete period and calculating the duty cycle of the lamp control signals, such that sampling errors and delays caused by an excessively long sampling time can be effectively avoided, and the situation that a lamp fails to be driven due to the lack of power transmission of the system when the coded signal is transmitted in a case where lamp control signals remain at a low duty cycle for an excessively long time is avoided. The signal header is used to avoid a cumulative error and improve decoding accuracy and reliability.

Step S4: the coded signal is superposed onto the integrated power to obtain composite power that is transmitted by a two-wire system.

Step S5: the composite power is received from the two-wire system and signal-power separation is performed on the composite power to obtain driving power and the coded signal for driving a load 6.

The coded signal obtained by synchronously sampling the level states of the R, G and B lamp control signals within the preset period is superposed onto the integrated power to obtain composite power which is transmitted by the two-wire system, such that system transformation from the four-wire system to the two-wire system is realized, and it is ensured composite signals and power can be synchronously transmitted in the two-wire system, such that the coded signal and power can be transmitted approximately synchronously at a low delay, and the integrated power can still be continuously transmitted in case of a low duty cycle of lamp control signals, thus satisfying the requirement for driving power of the load 6 and solving the problem that a lamp fails to be driven due to the lack of power of the system during two-wire signal transmission in case of a low duty cycle of lamp control signals. After the two-wire system performs signal-power separation on the composite power, driving power for driving the load 6 and the coded signal carrying load control information are obtained to drive and control the load 6.

Step S6: the coded signal is decoded, and after the signal header is read, timing is performed, and the three bits of coded data are read to obtain the R, G and B control information carried by the coded signal, and R, G and B control signals with a fixed duration are correspondingly output to the load 6.

Referring to FIG. 2, when the coded signal is decoded, every time after the signal header is read, the three bits of coded data corresponding to the R, G and B control information carried by the level states of the three lamp control signals are sequentially read after timing, and then R, G and B control signals, according to the R, G and B control information, with a fixed duration are output to the load 6 to control the load 6 to work.

In this embodiment, Step S2 further comprises: every time a corresponding coded signal is generated, the coded signal is output. Step S6 further comprises: after the R, G and B control signals with the fixed duration are generated, the R, G and B control signals are reset to an initial state, and a next coded signal is coded; wherein, the fixed duration is the same as the duration of the preset sampling period.

The level states of the R, G and B lamp control signals are synchronously sampled within the preset sampling period, and every time a coded signal is generated, the coded signal is transmitted. When the signal header is read, timing is performed and the coded signal is read, then the R, G and B control signals with the fixed duration are generated and then reset to the initial state, then the next coded signal is read, and new R, G and B control signals are generated and allocated to corresponding pins of the load 6. By cyclically performing Step S1 to Step S6, periodical sampling, packing and decoding of lamp control signals are realized, and the load 6 is controlled to operate according to set control data.

### Embodiment 2

Referring to FIGS. 1 and 3, Embodiment 2 is different from Embodiment 1 in the following aspect:

In Embodiment 2, in Step S2: a corresponding coded signal is generated according to the level states of the three lamp control signals and is output, wherein the coded signal comprises a signal header and three bits of coded data corresponding to R, G and B control information carried by the level states of the three lamp control signals.

Step S2 further comprises: every time a coded signal is generated, the current coded signal is compared with a previous coded signal; if the current coded signal is the same as the previous coded signal, the current coded signal will not be output; or if the current coded signal is different from the previous coded signal, the current coded signal is output.

Preferably, Step S6 further comprises: when a next signal header is read, retiming is performed, another three bits of coded data are read, and the output R, G and B control signals are updated; and if the next signal header is not read within a preset time, the R, G and B control signals are reset to an initial state. In this embodiment, if the current coded signal is the same as the previous coded signal, the current coded signal obtained by sampling will not be transmitted, and only a low-level signal will be transmitted. If the coded signal is not received exceeding a preset time and a low-level signal is received exceeding a set time, the R, G, and B control signals are reset to the initial state. In the present invention, the initial state of all of the R, G, and B control signals is the state of high level or the state of low level.

The level states of the R, G and B lamp control signals are synchronously sampled at a preset time point, and the coded signal is generated and compared with the previous sampling result. If the current coded signal is the same as the previous sampling result, the current coded signal will not be transmitted. If the current coded signal is different from the previous sampling result, the current coded signal will be transmitted to thereby update the R, G and B control signals. In this way, the data transmission quantity can be effectively reduced, the analysis process of the subsequent coded signal can be effectively simplified, and the signal transmission and analysis speed can be increased. If a new coded signal is not received within a long time, it indicates that a whole lamp control signal sampling period is completed, sampling is ended, and the R, G, and B control signals are reset to the initial state.

### Embodiment 3

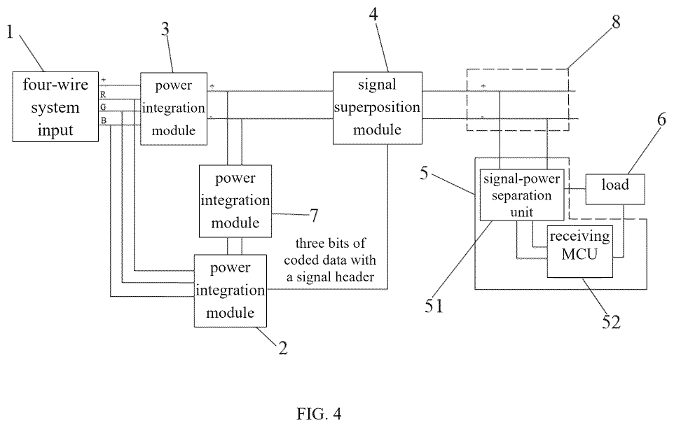

Referring to FIG. 4, the invention further provides a lamp control signal transmission system based on level sampling, which is suitable for the lamp control signal transmission method based on level sampling in any one of the above embodiments, and comprises a four-wire system input module 1, a sampling MCU 2, a power integration module 3, a signal superposition module 4, a two-wire system transmission module 8 and an analysis module 5.

Specifically, the four-wire system input module 1 is connected to an input terminal of the power integration module 3 by means of a positive wire, an R signal wire, a G signal wire and a B signal wire. An input terminal of the sampling MCU 2 is connected to the R signal wire, the G signal wire and the B signal wire, and an output terminal of the sampling MCU 2 is connected to the signal superposition module 4. The power integration module 3 is sequentially connected to the signal superposition module 4 and the two-wire system transmission module 8 by means of a positive wire and a negative wire. A composite output terminal of the two-wire system transmission module 8 is connected to a composite input terminal of the analysis module 5 by means of a signal wire and a negative wire b, and a composite output terminal of the analysis module 5 is connected to a load 6.

The four-wire system input module 1 is configured for generating R (red), G (green) and B (blue) lamp control signals and outputting the R, G and B lamp control signals respectively by means of the R signal wire, the G signal wire and the B signal wire.

The sampling MCU 2 is configured for sampling level states of the three lamp control signals, generating a corresponding coded signal according to the level states of the current three lamp control signals, and outputting the coded signal to the signal superposition module 4.

Wherein, the level states comprise a high level and a low level; the coded signal comprises a signal header and three bits of coded data corresponding to R, G and B control information carried by the level states of the three lamp control signals. In this embodiment, the signal header is a high level.

The power integration module 3 is configured for integrating power on the R signal wire, the G signal wire and the B signal wire with driving power on the positive wire to obtain integrated power.

The signal superposition module 4 is configured for superposing the coded signal onto the integrated power to obtain composite power and outputting the composite power to the two-wire system transmission module 8.

The two-wire system transmission module 8 comprises a positive wire connected to the positive wire and a negative wire connected to the negative wire, and is configured for transmitting the composite power and outputting the composition power to the analysis module 5.

The analysis module 5 comprises a signal-power separation unit 51 and a receiving MCU 52, wherein the signal-power separation unit 51 is configured for performing signal-power separation on the composite power to obtain driving power for driving a load 6, and the coded signal.

The receiving MCU 52 is configured for receiving and decoding the coded signal, after the signal header is read, performing timing and reading the three bits of coded data to obtain the R, G and B control information carried by the coded signal, and outputting corresponding R, G and B control signals to the load 6.

The lamp control signal transmission system based on level sampling further comprises an energy storage and voltage stabilization module 7, wherein one terminal of the energy storage and voltage stabilization module 7 is connected to the positive wire and the negative wire, and the other terminal of the energy storage and voltage stabilization module 7 is connected to the sampling MCU 2. The energy storage and voltage stabilization module 7 is configured for performing voltage stabilization and filtering on the coded signal generated and output by the sampling MCU 2 to ensure the quality and stability of the signal.

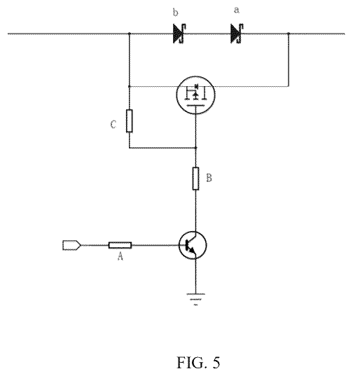

Referring to FIG. 5, the signal superposition module 4 is configured for superposing the coded signal onto the integrated power to obtain composite power and outputting the composite power to the two-wire system transmission module 8. The signal superposition module 4 comprises a triode, a resistor A, a resistor B, a MOS transistor, a diode a, a diode b and a resistor C, wherein a base of the triode is sequentially connected to the resistor A and an output terminal of the sampling MCU 2, an emitter of the triode is grounded, a collector of the triode is connected to the resistor B, the diode a is connected in series to the diode b and then connected in parallel to the MOS transistor, and the resistor C is connected between a drain and a gate of the MOS transistor and connected to an output terminal of the power integrated module 3; and the gate of the MOS transistor is connected to one terminal of the resistor B, and a source of the MOS transistor is connected to an input terminal of the two-wire system transmission module 8.

According to the lamp control signal transmission system based on level sampling provided by the invention, the sampling MCU synchronously samples the level states of the R, G and B lamp control signals in the four-wire system input module 1 within the preset sampling period, the corresponding coded signal comprising the signal header and the three bits of coded data corresponding to R, G and B control information carried by the level states of the three lamp control signals is generated, power of the three lamp control signals in the four-wire system input module 1 and driving power are integrated by the power integration module 3 to obtain integrated power, the signal superposition module 4 superposes the coded signal onto the integrated power to form composite power which is output to the analysis module 5 by the two-wire system transmission module 8, and finally, the analysis module 5 analyzes the composite power to control and drive the load 6, such that transformation from the four-wire lamp system to the two-wire lamp system is realized, the wiring cost is reduced, the universality and expandability of the system are improved, the coded signal can be transmitted approximately synchronously at a low delay, and the problem that the load 6 fails to be driven due to the lack of power of the system in case of a low duty cycle is solved, thus improving the operating stability of the system.

The preferred embodiments of the invention disclosed above are merely used to expound the invention, and the invention is not limited to the above specific embodiments. Obviously, other amendments and modifications can be made to the invention according to the above contents. Specific embodiments are selected and specifically described here for the purpose of better explaining the principle and actual application of the invention to allow those skilled in the art to better understand and use the invention and are not used for limiting the invention, and any schemes obtained by simply transforming the invention should also fall within the protection scope of the invention.

What is claimed is:

1. A lamp control signal transmission method based on level sampling, comprising:
Step S1: synchronously sampling, within a preset sampling period, level states of R (red), G (green) and B (blue) lamp control signals in a four-wire system to obtain level states of current R, G and B lamp control signals, wherein the level states comprise a high level and a low level;
Step S2: generating and outputting a coded signal according to the level states of the lamp control signals, wherein the coded signal comprises a signal header and three bits of coded data corresponding to R, G and B control information carried by the level states of the lamp control signals;
Step S3: integrating power of the three lamp control signals with power of a driving circuit in the four-wire system to obtain integrated power;
Step S4: superposing the coded signal onto the integrated power to obtain composite power that is transmitted by a two-wire system;
Step S5: receiving the composite power from the two-wire system and performing signal-power separation on the composite power to obtain driving power for driving a load, and the coded signal; and
Step S6: decoding the coded signal, and after the signal header is read, performing timing and reading the three bits of coded data to obtain the R, G and B control information carried by the coded signal, and correspondingly outputting R, G and B control signals with a fixed duration to the load.

2. The lamp control signal transmission method based on level sampling according to claim 1, wherein Step S2 further comprises:
every time one said coded signal is generated, outputting said coded signal.

3. The lamp control signal transmission method based on level sampling according to claim 2, wherein Step S6 further comprises:
after the R, G and B control signals with the fixed duration are generated, resetting the R, G and B control signals to an initial state, and then decoding a next coded signal, wherein the fixed duration is the same as a duration of the preset sampling period.

4. The lamp control signal transmission method based on level sampling according to claim 1, wherein Step S2 further comprises:
every time one coded signal is generated, comparing the current coded signal with a previous coded signal;
if the current coded signal is the same as the previous coded signal, not outputting the current coded signal; or, if the current coded signal is different from the previous coded signal, outputting the current coded signal.

5. The lamp control signal transmission method based on level sampling according to claim 1, wherein Step S6 further comprises:
when a next signal header is read, performing retiming and reading another three bits of coded data and updating the output R. G and B control signals; and if the next signal header is not read exceeding a preset time, resetting the R, G and B control signals to an initial state.

6. A lamp control signal transmission system based on level sampling, being suitable for the lamp control signal transmission method based on level sampling according to claim 1, the lamp control signal transmission system comprising a four-wire system input module, a sampling MCU, a power integration module, a signal superposition module, a two-wire system transmission module and an analysis module; wherein,
the four-wire system input module is connected to an input terminal of the power integration module by means of a first positive wire, an R signal wire, a G signal wire and a B signal wire;
an input terminal of the sampling MCU is connected to the R signal wire, the G signal wire and the B signal wire, and an output terminal of the sampling MCU is connected to the signal superposition module; the power integration module is sequentially connected to the signal superposition module and the two-wire system transmission module by means of a second positive wire and a first negative wire; a composite output terminal of the two-wire system transmission module is connected to a composite input terminal of the analysis module by means of a signal wire and a second negative wire, and a composite output terminal of the analysis module is connected to a load;
the four-wire system input module is used for generating R (red), G (green) and B (blue) lamp control signals and outputting the R, G and B lamp control signals respectively by means of the R signal wire, the G signal wire and the B signal wire;
the sampling MCU is used for sampling level states of three lamp control signals to obtain the level states of the current three lamp control signals, generating a corresponding coded signal according to the level states of the current three lamp control signals, and outputting the coded signal to the signal superposition module, wherein the level states comprise a high level and a low level; the coded signal comprises a signal header and three bits of coded data corresponding to R, G and B control information carried by the level states of the three lamp control signals;
the power integration module is configured for integrating power on the R signal wire, the G signal wire and the B signal wire with driving power on the first positive wire to obtain integrated power;
the signal superposition module is configured for superposing the coded signal onto the integrated power to obtain composite power and outputting the composite power to the two-wire system transmission module;
the two-wire system transmission module comprises a third positive wire connected to the second positive wire and a third negative wire connected to the first negative wire, and is configured for transmitting the composite power and outputting the composition power to the analysis module;
the analysis module comprises a signal-power separation unit and a receiving MCU; the signal-power separation unit is configured for performing signal-power separation on the composite power to obtain driving power for driving a load, and the coded signal;
the receiving MCU is configured for receiving and decoding the coded signal, after the signal header is read, performing timing and reading three bits of coded data to obtain R, G and B control information carried by the coded signal, and outputting corresponding R, G and B control signals to the load.

7. The lamp control signal transmission system based on level sampling according to claim 6, further comprising an energy storage and voltage stabilization module, wherein the energy storage and voltage stabilization module comprises a terminal connected to the second positive wire and the first negative wire, and another terminal connected to the sampling MCU.

8. The lamp control signal transmission system based on level sampling according to claim 6, wherein the signal superposition module comprises a triode, a first resistor, a second resistor, a MOS transistor, a first diode, a second diode and a third resistor, a base of the triode is sequentially connected to the first resistor and an output terminal of the sampling MCU, an emitter of the triode is grounded, a collector of the triode is connected to the second resistor, the first diode is connected in series to the second diode and then connected in parallel to the MOS transistor, and the third resistor is connected between a drain and a gate of the MOS transistor and connected to an output terminal of the power integrated module; and the gate of the MOS transistor is connected to a terminal of the second resistor, and a source of the MOS transistor is connected to an input terminal of the two-wire system transmission module.
